(19) United States
(12) Patent Application Publication
(10) Pub. No.: US 2020/0035114 A1
(43) Pub. Date: Jan. 30, 2020

(54) SEAT SUPPORT MECHANISM OF DRIVING SIMULATOR FOR FOUR-WHEELED AUTOMOBILE

(71) Applicant: IROC CO., LTD., Nagoya-shi, Aichi (JP)

(72) Inventor: Takuma KOGA, Nagoya-shi (JP)

(73) Assignee: IROC CO., LTD., Nagoya-shi, Aichi (JP)

(21) Appl. No.: 16/487,814

(22) PCT Filed: Mar. 23, 2018
(86) PCT No.: PCT/JP2018/011821

§ 371 Date: Aug. 21, 2019

(30) Foreign Application Priority Data
Mar. 30, 2017 (JP) 2017-066663

(51) Int. Cl. G09B 9/04; A47C 1/00; A47C 3/025

(52) U.S. Cl. CPC G09B 9/04; A47C 3/0251; A47C 3/0255; A47C 1/00

(57) ABSTRACT

A seat support mechanism of a driving simulator for a four-wheeled automobile includes a lower frame (2) that is supported on a base (1) at one front point by a universal joint (6) and at two back points by cylinder actuators (5). The seat support mechanism further includes an upper frame (3) that is supported on the lower frame at one front point by a universal joint (8) and at two back points by cylinder actuators (7). The one front point and the two back points are arranged so as to form a substantially isosceles triangle that has the one front point as the apex, and a seat is mounted on and fixed to the upper frame.

### CROSS-REFERENCE TO RELATED APPLICATIONS

The present application is based on Japanese Patent Application No. 2017-066663, filed on Mar. 30, 2017, the entire contents of which are incorporated herein by reference.

### TECHNICAL FIELD

The present disclosure relates to a seat support mechanism that supports a seat of a driving simulator that enables a driver to experience driving of a four-wheeled automobile in simulation.

### BACKGROUND ART

Japanese Unexamined Patent Application Publication No. 11-219102 (PTL 1) describes an example of a driving simulator that enables a driver of a four-wheeled automobile to simulate driving on a road. PTL 1 proposes a seat support device in which a rotatable bearing supports a back part of a driver-seat mount plate and a link mechanism rotates the driver-seat mount plate. Driven by a servomotor, the seat support mechanism enables a driver to physically experience situations during acceleration, deceleration, and collision, from the inclination of a seat position.

### CITATION LIST

### Patent Literature

PTL 1: Japanese Unexamined Patent Application Publication No. 11-219102

### SUMMARY OF INVENTION

The driving simulator described in PTL 1 can mainly simulate acceleration, deceleration, collision, and the like. However, it is difficult for the driving simulator to enable a driver to accurately and physically experience actual automobile situations, such as reproduction of a squeak of tires, a shock that tires receive from bumps on a road, a G-force (acceleration) and a centrifugal force during acceleration/deceleration and turning, and an action of a shock absorber.

There is a flight simulator that includes six cylinder actuators. However, the flight simulator is not suitable for accurately simulating a squeak of tires of a four-wheeled automobile, a shock that tires receive from bumps on a road, and a G-force (acceleration) and a centrifugal force during acceleration/deceleration and turning. Moreover, because the device has a large size and requires high diving power, the manufacturing cost and the operation cost may both increase.

An object the present disclosure is to provide a seat support mechanism of a driving simulator that has a simple and compact structure and that enables a driver to physically experience a squeak of tires, a shock that tires receive from bumps on a road, and a G-force (acceleration) and a centrifugal force during acceleration/deceleration and turning.

(Regarding Claim 1)

A seat support mechanism of a driving simulator for a four-wheeled automobile includes a base; a lower frame that is supported by support members on the base at three points including one front point and two back points; an upper frame that is supported by support members on the lower frame at three points including one front point and two back points; and a seat that is fixed to the upper frame. The support members that support the lower frame on the base at the two back points are cylinder actuators that contain actuators, lower ends of the cylinder actuators are coupled to the base via universal joints, upper ends of the cylinder actuators are coupled to the lower frame via universal joints, and the support member that supports the lower frame on the base at the one front point is coupled to the base via a universal joint.

Thus, the sheet support mechanism has a structure such that the two back points of the lower frame are suspended by the cylinder actuators. This simple structure can reproduce the details of a squeak of tires and a shock that tires receive from bumps on a road.

The support members that support the upper frame on the lower frame at the two back points are cylinder actuators that contain actuators, lower ends of the cylinder actuators are coupled to the lower frame via universal joints, upper ends of the cylinder actuators are coupled to the upper frame via universal joints, and the support member that supports the upper frame on the lower frame at the one front point is coupled via a universal joint. A support body that supports the upper frame at the one front point is a universal joint.

Thus, the sheet support mechanism has a structure such that the two back points of the upper frame are suspended by the cylinder actuators, that is, a floating structure. This simple structure can reproduce the details of a G-force due to acceleration/deceleration of a four-wheeled automobile, a centrifugal force, and the like that are applied to a seat.

(Regarding Claim 2)

The one front point and the two back points where the lower frame is supported on the base are positioned at vertices of an isosceles triangle that has the one front point as an apex, and the one front point and the two back points where the upper frame is supported on the lower frame are positioned at vertices of an isosceles triangle that has the one front point as an apex.

Thus, control of the cylinder actuators is even on the left and right sides, and the control device can easily perform driving simulation of a four-wheeled automobile.

(Regarding Claim 3)

The cylinder actuators are cylinder actuators that contain electric actuators.

Thus, the electric actuators can reproduce motions in further detail and with highly sensitive response. The electric actuators can be made compact compared with fluid actuators that use hydraulic pressure or the like, because pipes and the like are not necessary.

(Regarding Claim 4)

The base and the lower frame are coupled to each other and the lower frame and the upper frame are coupled to each other respectively by torsion bars, both ends of each of which are coupled via universal joints.

Thus, the torsion bars, each of which has the function of a connecting rod and a torsion bar, absorb elastic energy and thereby cancel out instability due to support using the universal joints.

### BRIEF DESCRIPTION OF DRAWINGS

The aforementioned object, other objects, features, and advantageous effects of the present disclosure will become more apparent from the following detailed description with reference to the attached drawings. The drawings are:

FIG. 1 is a back perspective view illustrating a driving simulator in operation;

FIG. 2 is a schematic view simply illustrating a frame structure of a seat support mechanism;

FIG. 3 is a front view of the seat support mechanism;

FIG. 4 is a plan view of the seat support mechanism; and

FIG. 5 is a back view of the seat support mechanism.

### DESCRIPTION OF EMBODIMENTS

A seat support mechanism of a driving simulator for a four-wheeled automobile according to the present disclosure includes: a lower frame that is supported by support bodies on a base at three points including one front point and two back points; an upper frame that is supported by support bodies on the lower frame at three points including one front point and two back points; and a seat that is fixed to the upper frame.

The support bodies that support the lower frame at the two back points are cylinder actuators that contain actuators. Lower ends of the cylinder actuators are coupled to the base via universal joints, and upper ends of the cylinder actuators are coupled to the lower frame via universal joints. The support body that supports the lower frame at the one front point is a universal joint.

The support bodies that support the lower frame on the base at the two back points are cylinder actuators that contain actuators. Lower ends of the cylinder actuators are coupled to the base via universal joints, and upper ends of the cylinder actuators are coupled to the lower frame via universal joints. The support body that supports the lower frame on the base at the one front point is a universal joint.

The cylinder actuators are cylinder actuators that contain electric actuators. Driving of the electric actuators is controlled by a control device, and the electric actuators can freely simulate, for example, vibration of a seat, and the inclinations and displacements in the front-back directions and the lateral (sideways) directions.

The base and the lower frame are coupled to each other and the lower frame and the upper frame are coupled to each other respectively by torsion bars, both ends of each of which are coupled via joints. Because the upper frame and the lower frame are each coupled at three points via universal joints, although the degree of freedom is high, the sheet support device may become unstable. The torsion bars have a function of absorbing torsional elastic energy due to support of the lower frame relative to the base and support of the upper frame relative to the lower frame. Thus, the torsion bars stabilize the sheet support device.

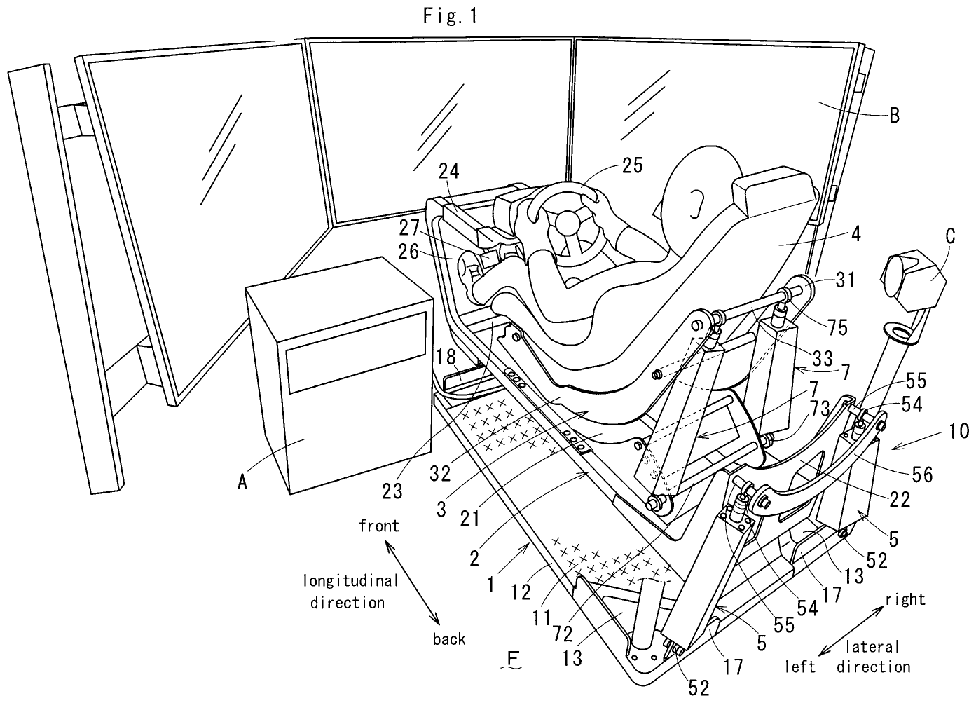

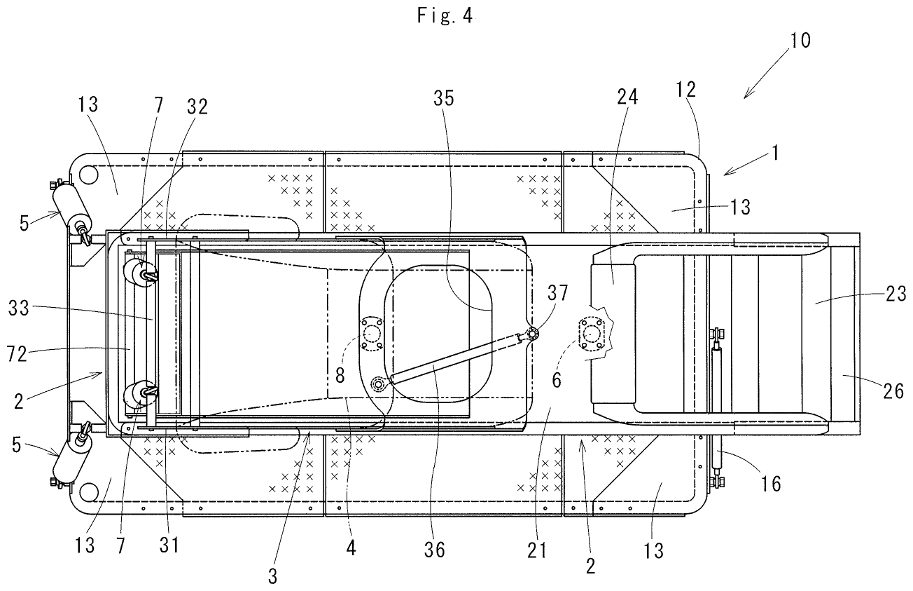

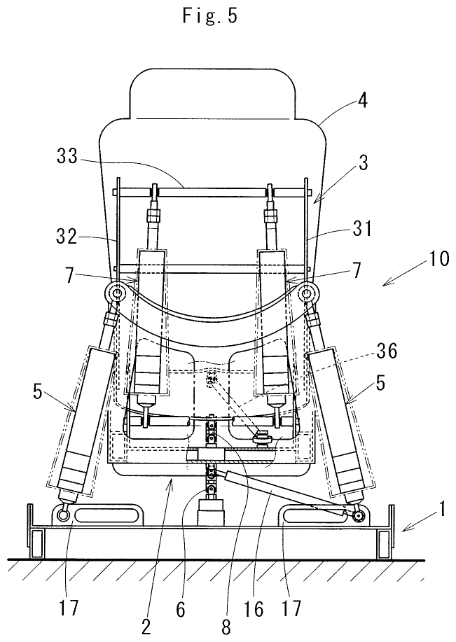

Hereafter, an embodiment illustrated in FIGS. 1 to 5 will be described.

### First Embodiment

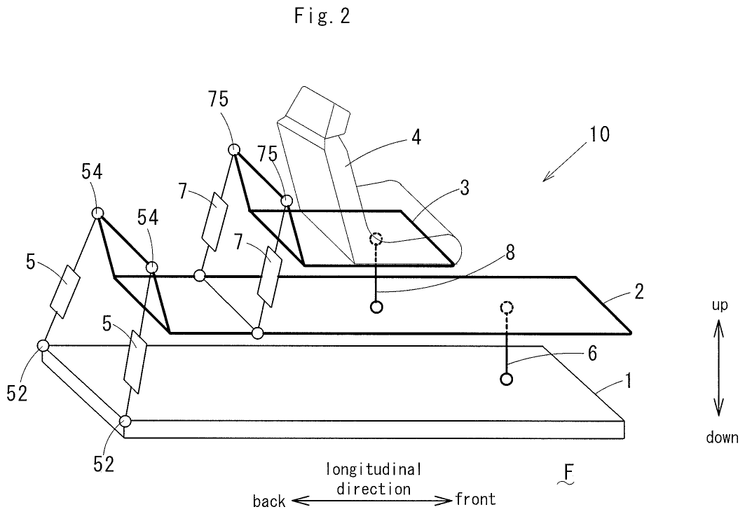

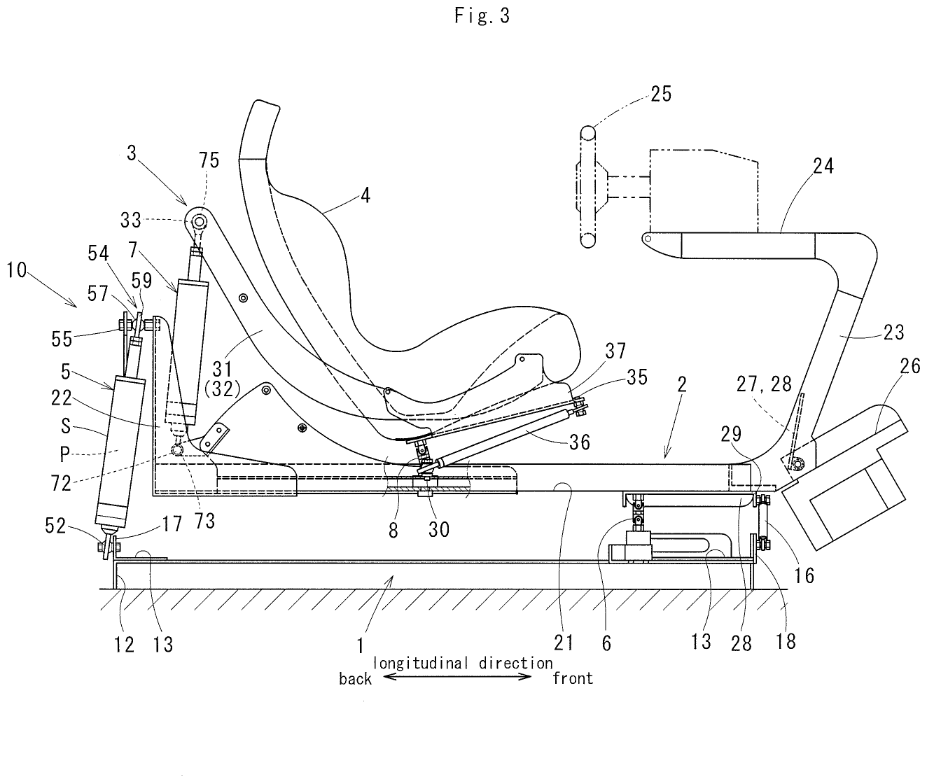

FIG. 1 illustrates an overview of a driving simulator for a four-wheeled automobile including a seat support mechanism 10 according to the present disclosure. FIG. 2 is a schematic view of a frame structure of the seat support mechanism 10 according to the present disclosure. FIGS. 3 to 5 are respectively a front view, a plan view, and a back view of the seat support mechanism 10.

The seat support mechanism 10 includes a base 1 that is set on a floor F, a lower frame 2 that is supported at three points on the base 1, an upper frame 3 that is supported at three points on the lower frame 2, and a seat 4 that is fixed to the upper frame 3. “A” denotes a control device of the driving simulator, “B” denotes a display device for displaying driving conditions, and “C” denotes an acoustic device.

The base 1 includes a rectangular base plate 11 that is elongated in the longitudinal direction, and a rectangular frame 12 that extends downward from an outer periphery of the rectangular base plate 11. Corner members 13, each of which is shaped like a triangular plate, are welded to the four corners of the base 1. Coupling pieces 17 extend upward from the corner members 13 at the back side.

The lower frame 2 has a rectangular shape that is elongated in the longitudinal direction, that has a width that is approximately a half of the width of the base 1, and that has a length that is approximately the same as the length of the base 1. The lower frame 2 is substantially horizontally disposed above the base 1. The lower frame 2 includes a bottom portion 21, a back frame 22 that extends upward from a back end of the bottom portion 21, and a front frame 23 that extends diagonally upward from a front end of the bottom portion 21. A desk frame 24 extends horizontally backward from an upper end of the front frame 23. A steering wheel mechanism 25 is set on the desk frame 24. A footrest 26 is additionally attached to a central part of the front end of the bottom portion 21 so as to be inclined. A brake pedal 27 and an accelerator pedal 28 are set on a side part of the footrest 26.

The upper frame 3 includes left and right side members 31 and 32 that are curved, a horizontal coupling bar 33 that couples back end parts of the side members 31 and 32 to each other, and a middle coupling bar that couples middle parts of the side members 31 and 32 to each other. A seat-setting frame 35, which has a substantially rectangular shape, is formed at front parts of the left and right side members 31 and 32. The seat 4 is set on and fixed to the seat-setting frame 35. Various seats can be replaceably used as the seat 4.

The lower frame 2 is coupled to the base 1 so as to be supported at three points including two back points and one front point. The three points are arranged in the shape of an isosceles triangle that has the one front point as the apex in an imaginary projection plane. Support mechanisms at the two back points are supported via cylinder actuators 5 that contain actuators. The support mechanisms transmit displacements and action forces that are generated as the cylinder actuators 5 operate. A support mechanism at the one front point is a universal joint 6, and has a structure for absorbing a change in the angle thereof even when flexion such as swinging occurs, although the support mechanism needs to transmit a rotational force and a displacement.

A coupling piece 18 extends upward from a front part of the rectangular frame 12 of the base 1. A first end of a torsion bar 16 is coupled to the coupling piece 18 via a joint. A second end of the torsion bar 16 is coupled to a front-end central portion 29 of the lower frame 2 via a joint. The torsion bar 16 has a function of absorbing torsional elastic energy due to instability of joints, which occurs because support with the lower frame 2 is all performed by using universal joints. Thus, the torsion bar 16 operates to stabilize the support device.

First ends of the cylinder actuators 5 are joined to the coupling pieces 17 of the corner plates 13 via universal joints 52. Second ends of the cylinders 5 are joined to left and right side parts of an upper end part of the back frame 22 via universal joints 54.

The universal joints 54 fix pins 55 that are fixed to a back surface of the upper end part of the back frame 22. End portions of the pins 55 are coupled and fixed to each other by using a coupling member 56, which is an arc-shaped plate. Spherical portions 57 are formed at middle parts of the pins 55. Couplers 59, which are rotatable with the spherical portions 57, are disposed at upper end parts of pistons 58 contained in the cylinder actuators 5.

The upper frame 3 is coupled to the lower frame 2 so as to be supported at three points including two back points and one front point. The three points are arranged in the shape of an isosceles triangle that has the one front point as the apex in an imaginary projection plane. Support mechanisms at the two back points are cylinder actuators 7 that contain actuators. A support mechanism at the one front point is a universal joint 8.

A middle portion 30 of the lower frame 2 and a front-end central portion 37 of the upper frame 3 are linked to each other by a torsion bar 36, both ends of which are coupled via joints. The upper frame 3 and the lower frame 2 are all supported at three points via universal joints. Therefore, the position of the upper frame 3 relative to the lower frame 2 tends to become unstable, and the torsion bar 36 has a function of stabilizing the position of the upper frame 3 relative to the lower frame 2.

Lower ends of the cylinder actuators 7 are coupled to a lateral bar 72, which is horizontally set at a lower part of the back frame 22, via universal joints 73. Upper ends of the cylinder actuators 7 are coupled to the horizontal coupling bar 33, which is set at upper end parts of the left and right side members 31 and 32 of the upper frame 3, via universal joints 75. The structure of each of the universal joints 73 and 75 is the same as the structure of each of the universal joints 52 and 54.

The cylinder actuators 5 and 7, which contain actuators, have the same structure. Each of the cylinder actuators 5 and 7 includes a cylinder S and a piston P whose lower part is contained in the cylinder S. An electrical actuator is contained in the cylinder S. The cylinder actuators 5 and 7 are controlled by the control device A of the driving simulator.

As described above, the present embodiment has the following features. The upper frame 3, on which the seat 4 is mounted and fixed, is supported at three points that form a substantially isosceles triangle, with one of the points corresponding to the apex is rotatably supported, the remaining two points are rotatably supported via the two-axis actuators 7, and a floating configuration is formed.

Likewise, the lower frame 2, which supports the upper frame 3 in a floating manner, is supported at three points that form a substantially isosceles triangle, with one of the points corresponding to the apex is rotatably supported, the remaining two points are rotatably supported via the two-axis actuators 5, and a floating configuration with respect to the base 1 is formed.

That is, the present embodiment uses a floating four-axis motion type having a configuration such that frames, each of which can realize two-axis motion, are suspended in two tiers.

Thus, with the two axes of the cylinder actuators 7, which move together with the seat 4, it is possible to realistically reproduce motions of even a racing car without sacrificing driving positions. With the two axes of the cylinder actuators 5 of the lower frame 2, it enables a driver to sensitively feel the grip of tires.

Thus, the four-axis cylinder actuators 5 and 7 can reproduce various situations during driving of a four-wheeled automobile, such as a squeak of tires, a shock that tires receive from bumps in a road, and a G-force (acceleration) and a centrifugal force during acceleration/deceleration and turning. As a result, a driver can physically experience such situations. Moreover, by changing control conditions of the control device A, it is possible to simulate a drive feeling that is novel.

A seat support device according to the present disclosure reproduces driving situations of a four-wheeled automobile by using the following structure: the lower frame 2 is suspended and supported at two back points by using two cylinder actuators that contain electrical driving devices, and the upper frame 2 is suspended and supported at two back points by using two cylinder actuators that contain electrical driving devices. Therefore, the seat support device enables a wide range of driving simulations of a four-wheeled automobile with a simple and compact structure.

Although the present disclosure has been described based on an embodiment, it should be understood that the present disclosure is not limited to the embodiment and the structure. The present disclosure encompasses various modified embodiments and modifications within the scope of equivalents. In addition, various combinations and configurations and other combinations and configurations that further include only one or more additional elements or fewer elements, are also included in the category and the scope of the present disclosure.

1. A seat support mechanism of a driving simulator for a four-wheeled automobile, comprising:
a base (1);
a lower frame (2) that is supported by support members on the base at three points including one front point and two back points;
an upper frame (3) that is supported by the support members on the lower frame at three points including one front point and two back points; and
a seat (4) that is fixed to the upper frame,
wherein the support members that support the lower frame on the base at the two back points are cylinder actuators (5) that contain actuators, lower ends of the cylinder actuators are coupled to the base via universal joints, upper ends of the cylinder actuators are coupled to the lower frame via universal joints, and one of the support members (6) that supports the lower frame on the base at the one front point is coupled to the base via a universal joint, and
wherein the support members that support the upper frame on the lower frame at the two back points are cylinder actuators (7) that contain actuators, lower ends of the cylinder actuators are coupled to the lower frame via universal joints, upper ends of the cylinder actuators are coupled to the upper frame via universal joints, and one of the support members (8) that supports the upper frame on the lower frame at the one front point is coupled via a universal joint.

2. The seat support mechanism of a driving simulator for a four-wheeled automobile according to claim 1,
wherein the one front point and the two back points where the lower frame is supported on the base are positioned at vertices of an isosceles triangle that has the one front point as an apex, and the one front point and the two back points where the upper frame is supported on the lower frame are positioned at vertices of an isosceles triangle that has the one front point as an apex.

3. The seat support mechanism of a driving simulator for a four-wheeled automobile according to claim 1,
wherein the cylinder actuators are cylinder actuators that contain electric actuators.

4. The seat support mechanism of a driving simulator for a four-wheeled automobile according to claim 1,
wherein the base and the lower frame are coupled to each other and the lower frame and the upper frame are coupled to each other respectively by torsion bars (16, 36), both ends of each of which are coupled via universal joints.

5. The seat support mechanism of a driving simulator for a four-wheeled automobile according to claim 2,
wherein the cylinder actuators are cylinder actuators that contain electric actuators.

6. The seat support mechanism of a driving simulator for a four-wheeled automobile according to claim 2,
wherein the base and the lower frame are coupled to each other and the lower frame and the upper frame are coupled to each other respectively by torsion bars (16, 36), both ends of each of which are coupled via universal joints.

7. The seat support mechanism of a driving simulator for a four-wheeled automobile according to claim 3,
wherein the base and the lower frame are coupled to each other and the lower frame and the upper frame are coupled to each other respectively by torsion bars (16, 36), both ends of each of which are coupled via universal joints.
